(19) United States
(12) Patent Application Publication
(10) Pub. No.: US 2015/0317006 A1
(43) Pub. Date: Nov. 5, 2015

(54) DIGITAL DEVICE PROVIDING TOUCH REJECTION AND METHOD OF CONTROLLING THEREFOR

(71) Applicant: LG Electronics Inc., Seoul (KR)

(72) Inventors: Eunhyung CHO, Seoul (KR); Doyoung LEE, Seoul (KR)

(21) Appl. No.: 14/323,628

(22) Filed: Jul. 3, 2014

(30) Foreign Application Priority Data
May 2, 2014 (KR) 10-2014-0053524

(51) Int. Cl. G06F 3/041

(52) U.S. Cl. CPC G06F 3/041

(57) ABSTRACT

The present specification relates to a digital device providing touch rejection and a method of controlling therefor. A method of controlling a digital device having a single shape and an expand shape, comprising the steps of detecting a first touch input touching a first area of the digital device in the single shape, executing a first operation based on the detected first touch input, and cancelling the first operation upon detecting that the digital device is changed to the expand shape from the single shape while the first touch input is maintained.

This application claims the benefit of the Korean Patent Application No. 10-2014-0053524, filed on May 2, 2014, which is hereby incorporated by reference as if fully set forth herein.

### BACKGROUND OF THE INVENTION

1. Field of the Invention

The present specification relates to a digital device providing touch rejection and a method of controlling therefor.

2. Discussion of the Related Art

A digital device can include a plurality of display areas. In this case, the digital device can be manufactured in a manner that the digital device is foldable. When the digital device switches to an unfolded state from a folded state, the digital device can display visual information in a plurality of the display areas. And, the digital device can be equipped with a rollable display area capable of being stored and exposed. And, the digital device can be constructed with a flexible material and can include a plurality of display areas. In particular, the digital device includes a plurality of the display areas providing visual information and the visual information can be displayed one of a plurality of the display areas.

In this case, the digital device may have a single shape or an expand shape. More specifically, the digital device may have the single shape providing the visual information in a single display area only. And, the digital device may have the expand shape providing the visual information in a plurality of the display areas. In particular, the digital device can have shapes different from each other based on a display area providing the visual information.

In this case, it is necessary to have a method of controlling a control input while a shape of the digital device is changed. More specifically, it is necessary to have a method of controlling the digital device in a manner of distinguishing a control input intended by a user from a control input not intended by the user in the course of changing the shape of the digital device.

### SUMMARY OF THE INVENTION

Accordingly, the present specification is directed to an apparatus and method thereof that substantially obviate one or more problems due to limitations and disadvantages of the related art.

An object of the present specification is to provide a digital device providing touch rejection and a method of controlling therefor.

When a digital device includes a plurality of display areas, another object of the present specification is to provide a method of controlling a plurality of the display areas providing visual information based on a shape of the digital device.

Another object of the present specification is for a digital device to execute an operation based on a touch input.

In case of detecting a changing of a shape of a digital device while the digital device executes an operation and a touch input is maintained, another object of the present specification is to provide a method for the digital device to cancel the operation.

Another object of the present specification is to provide a method of deactivating a touch sensor unit for changing time corresponding to time that a shape of the digital device is changed.

In case that a shape of a digital device is changed, another object of the present specification is to provide a method of not using a maintaining touch input as a control input controlling the digital device.

In case that a shape of a digital device is changed, another object of the present specification is to provide a method of detecting a maintaining touch input as a new touch input.

In case that a digital device displays visual information, the other object of the present specification is to provide a method of controlling the digital device based on a touch input touching the visual information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment; a digital device having a single shape and an expand shape includes a touch sensor unit configured to detect a touch input touching a first area of the digital device and configured to deliver the detected touch input to a processor, a sensor unit configured to detect a change from the single shape to the expand shape and the processor configured to control the touch sensor unit and the sensor unit, if a first touch input touching the first area is detected in the single shape, the processor configured to execute a first operation based on the detected first touch input, if the digital device is changed from the single shape to the expand shape while the first touch input is maintained, the processor configured to cancel the first operation.

According to the present specification, it may provide a digital device providing touch rejection and a method of controlling therefor.

A digital device includes a plurality of display areas and can control a plurality of the display areas providing visual information based on a shape of the digital device.

A digital device can execute an operation based on a touch input.

In case of detecting a changing of a shape of a digital device while the digital device executes an operation and a touch input is maintained, the digital device can cancel the operation.

A digital device can deactivate a touch sensor unit for changing time corresponding to time that a shape of the digital device is changing.

In case that a shape of a digital device is changing, the digital device may not use a maintaining touch input as a control input controlling the digital device.

In case that a shape of a digital device is changing, the digital device can detect a maintaining touch input as a new touch input.

In case that a digital device displays visual information, the digital device can control the digital device based on a touch input touching the visual information.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram for a digital device according to one embodiment of the present specification;

FIG. 2 is a diagram for a touch input maintained while a digital device is changed from a single shape to an expand shape according to one embodiment of the present specification;

FIG. 3 is a diagram of a method for a digital device to cancel an operation and execute touch rejection according to one embodiment of the present specification in case that a changing of the digital device from a single shape to an expand shape is detected;

FIG. 4 is a diagram of a method for a digital device to cancel an operation and execute touch rejection according to one embodiment of the present specification in case that a changing of the digital device from an expand shape to a single shape is detected;

FIG. 5 is a diagram of a method for a digital device to detect a maintained touch input as a new touch input after the digital device has changed to an expand shape from a single shape according to one embodiment of the present specification;

FIG. 6 is a diagram of a method for a digital device to execute touch rejection on each of a first area of the digital device and a second area of the digital device according to one embodiment of the present specification;

FIG. 7 is a diagram of a method for a flexible digital device to change from a single shape to an expand shape according to one embodiment of the present specification;

FIG. 8 is a diagram of a method for a foldable digital device to change from a single shape to an expand shape according to one embodiment of the present specification;

FIG. 9 is a diagram of a method for a digital device to display visual information in a second area of the digital device based on a touch input touching the visual information displayed in a first area of the digital device according to one embodiment of the present specification;

FIG. 10 is a flowchart for a method of controlling a digital device according to one embodiment of the present specification.

### DETAILED DESCRIPTION OF THE INVENTION

While embodiments have been described in detail with reference to the attached drawings and contents written on the drawings, the scope of claims may be non-restricted or non-limited by the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

In the present specification, a digital device 100 may indicate an electronic device detecting an input of a user and displaying visual information with a display unit. More specifically, the digital device 100 may correspond to a smartphone, a smart pad, a tablet, a PDA, a notebook, or the like. Besides, the digital device 100 may correspond to a device detecting a control input of a user and displaying the visual information, by which the present specification may be non-limited.

And, the digital device 100 can include a plurality of areas. In this case, as an example, the digital device 100 can include a rollable area capable of being stored and exposed. The digital device 100 expands in a manner of exposing the rollable area from a stored position and can control an expanded area. And, as an example, the digital device may correspond to a foldable device. In this case, the digital device 100 can expand an area by changing to an unfolded state from a folded state. The digital device 100 can control the expanded area. And, as an example, the digital device may correspond to a flexible device. If the digital device is folded or rolled up, the digital device 100 can control a limited area. In this case, if the digital device 100 is unfolded again, the digital device 100 can expand the limited area. The digital device 100 can control the expanded area.

In particular, the digital device 100 has a plurality of areas and can selectively control a plurality of the areas.

And, the digital device 100 can have a single shape or an expand shape. In this case, a shape of the digital device 100 may correspond to a physical form of the digital device 100. As an example, the digital device 100 has a first body and a second body and may be equipped with a folding unit. If the first body and the second body are folded with each other on the basis of the folding unit, the digital device can be configured as the single shape. And, if the first body and the second body are unfolded on the basis of the folding unit, the digital device can be configured as the expand shape. In particular, the digital device 100 can be configured as the single shape or the expand shape based on the physical form of the digital device 100. And, as an example, the digital device 100 can have a rollable area capable of being stored and exposed. In this case, if the rollable area is stored, the digital device 100 can be configured as the single shape. And, if the rollable area is exposed, the digital device 100 can be configured as the expand shape. As a different example, the digital device 100 may correspond to a flexible device and can be folded. In this case, if the digital device is folded, the digital device can be configured as the single shape. If the digital device 100 is unfolded, the digital device 100 can be configured as the expand shape.

And, the digital device 100 can have a first area and a second area. If the digital device 100 is configured as the single shape, the digital device may provide the first area to a user as a control area among the first area and the second area. In this case, as an example, the digital device 100 detects a touch input touching the first area only and can deliver the detected touch input to a processor. And, as an example, the digital device 100 can display visual information in the first area only. In particular, the digital device 100 can provide the first area as a display area to the user as an area controllable by the user in the single shape.

And, if the digital device 100 is configured as the expand shape, the digital device can provide the first area and the second area to the user as a control area. In this case, as an example, the digital device 100 detects a touch input on the first area and the second area and can deliver the detected touch input to the processor. And, as an example, the digital device 100 can display visual information in both the first area and the second area. In particular, the digital device 100 can provide a plurality of areas to the user as an area controllable by the user in the expand shape.

In this case, the second area may correspond to an area expanded from the first area based on a shape of the digital device 100. As an example, the second area may correspond to an area expanded from the first area in a manner of being exposed from the digital device 100 which has stored the second area. And, the second area may correspond to an area expanded from the first area in a manner of being unfolded from a foldable device or a flexible device. In particular, digital device 100 can have the second area as a separate area discriminated from the first area. The digital device 100 can selectively control the first area and the second area based on a shape of the digital device 100, by which the present specification may be non-limited.

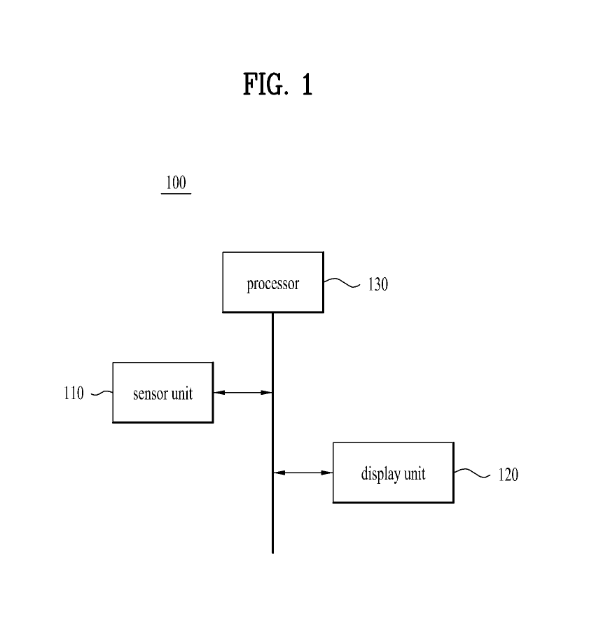

FIG. 1 is a block diagram for a digital device according to one embodiment of the present specification. The digital device 100 can include a sensor unit 110, a display unit 120 and a processor 130.

The sensor unit 110 detects an input signal and can deliver the detected input signal to the processor. In this case, the input signal may correspond to a touch input. More specifically, the sensor unit 110 can detect a touch input touching at least one of the first area and the second area of the digital device 100. In this case, the first area and the second area correspond to areas had in the digital device 100 and may correspond to areas capable of detecting the touch input. And, as an example, the input signal may correspond to one selected from the group consisting of a tilt of the digital device, an input of an input device, an audio input and a gesture input. And, the input signal may correspond to a control input of a user controlling the digital device, by which the present specification may be non-limited. And, the sensor unit 110 may include an input device (not depicted) to detect an input signal.

As an example, the sensor unit 110 can detect a touch input using a touch sensor. And, as an example, the sensor unit 110 can detect various control inputs using at least one of an image sensor and a voice recognition sensor, by which the present specification may be non-limited. In particular, the sensor unit 1120 delivers a detected input signal to the processor and the processor can control the digital device 100 using the delivered input signal.

And, the sensor unit 110 can detect that the digital device 100 is changed from an single shape to and expand shape. More specifically, the digital device 100 can detect a changing of a physical form of the digital device 100 using the sensor unit 110. In this case, the sensor unit 110 can include at least one selected from the group consisting of an acceleration sensor, a terrestrial magnetism sensor, a vibration sensor and a power sensor and may include a sensor capable of detecting a change of the physical form of the digital device 100, by which the present specification may be non-limited.

And, the aforementioned sensors may be included in the digital device 100 as a separate element or may be included in the digital device in a manner of being integrated into one or more elements. In particular, the digital device 100 may include a composite sensor including the aforementioned sensors or may include individual sensors.

The display unit 120 can display visual information. More specifically, the display unit 110 can display the visual information in at least one of the first area and the second area of the digital device 100. In this case, the display unit 120 can control the displayed visual information based on a shape of the digital device 100. More specifically, if the digital device 100 is configured by the single shape, the display unit 120 can display the visual information in the first area of the digital device 100. If the digital device 100 is configured by the expand shape, the display unit 120 can display the visual information in at least one of the first area and the second area of the digital device 100.

And, as an example, the display unit 120 may correspond to a touch sensitive digital unit. The touch sensitive digital unit provides visual information to a user and can detect a touch input of the user. According to embodiment, the display unit 120 can include at least one selected from the group consisting of an OLED (organic light-emitting diode), a LCD (liquid crystal display), an E-ink, an HMD (head mounted display) and a flexible digital.

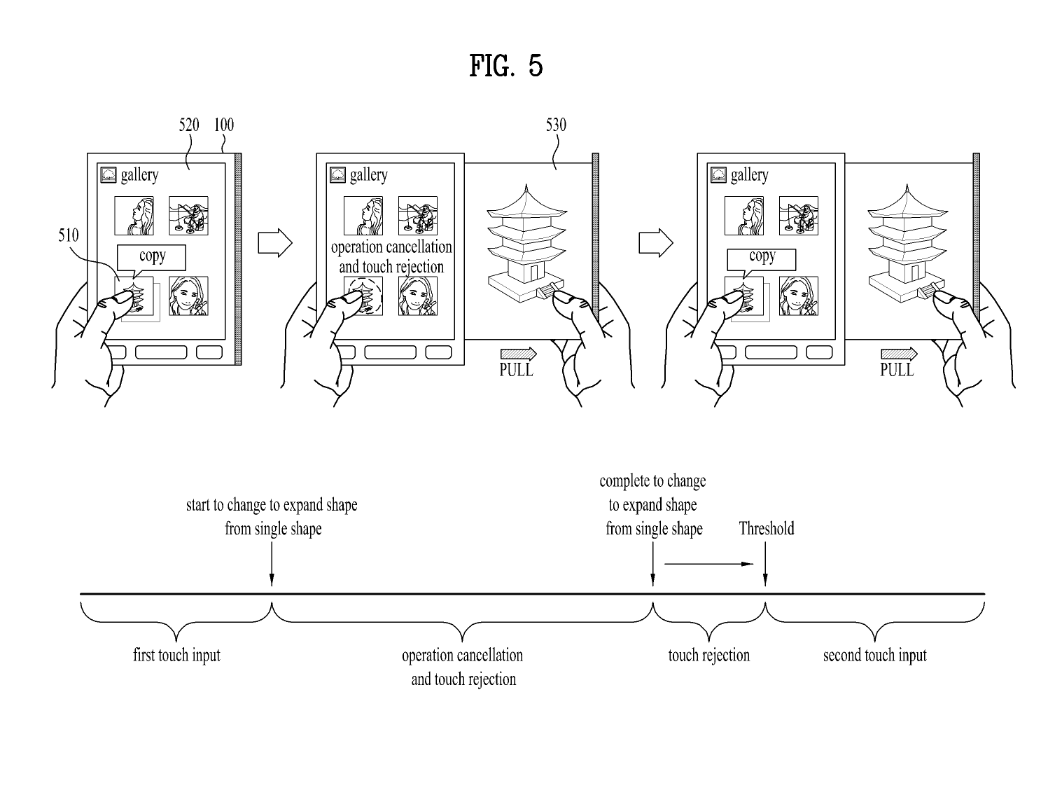

When the digital device 100 is in the single shape, the processor 130 can detect a first touch input touching the first area. The processor 130 can execute a first operation based on the detected first touch input. In this case, if it is detected that the digital device 100 is changed from the single shape to the expand shape while the first touch input is maintained, the processor 130 can cancel the first operation. More specifically, the processor 130 can execute the first operation based on the first touch input in the single shape. In this case, as an example, the first operation may correspond to an operation displaying an editing menu. And, as an example, the first operation may correspond to an operation moving an object displayed in a position on which a touch input is detected based on a long touch input. In particular, the first operation may correspond to a function which is executed based on a touch input, by which the present specification may be non-limited. The processor 130 can detect that the digital device 100 is changed from the single shape to the expand shape while the first operation is executing and the first touch input is maintained. Having detected the changing of the digital device from the single shape to the expand shape, the processor 130 can cancel the first operation. Regarding this, it shall be described later with reference to FIG. 5.

And, as an example, the processor 130 can execute a second operation based on an operation of changing from the single shape to the expand shape. In this case, the second operation may correspond to an operation irrespective of the first operation. In particular, the processor 130 can execute an additional function based on the operation of changing from the single shape to the expand shape, by which the present specification may be non-limited.

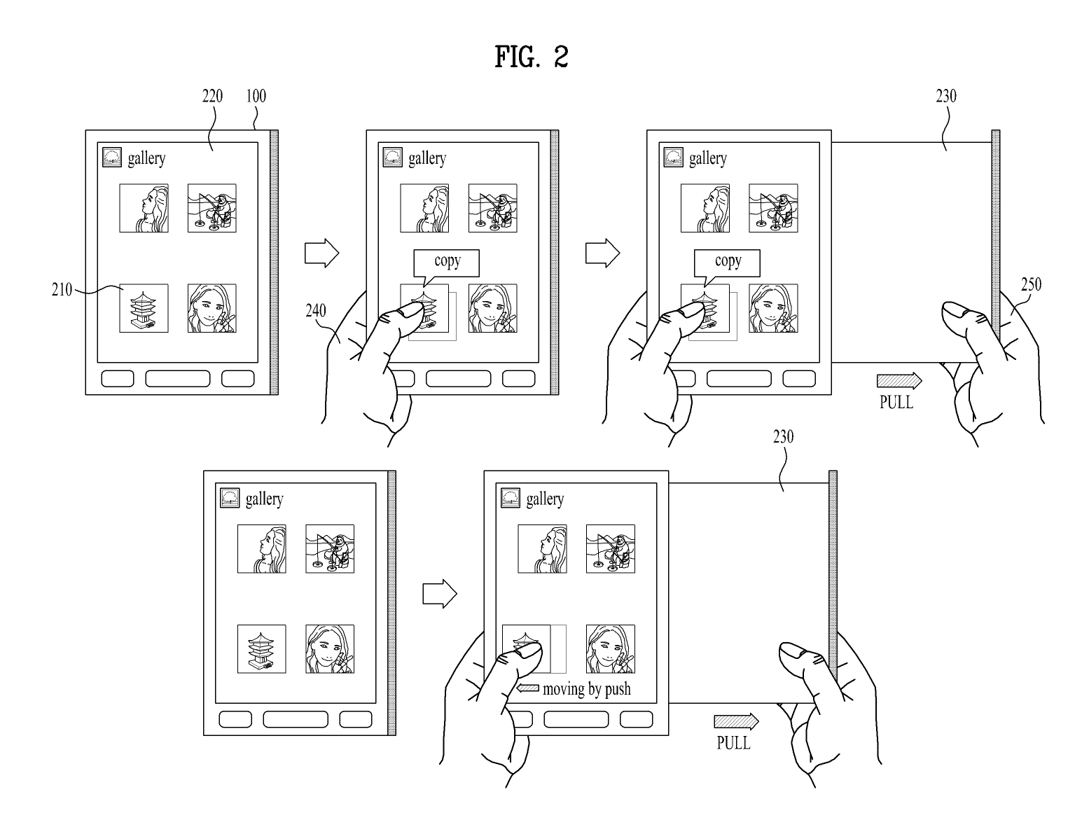

FIG. 2 is a diagram for a touch input maintained while a digital device is changed from a single shape to an expand shape according to one embodiment of the present specification.

The digital device 100 can have a first area 220 and a second area 230. The digital device 100 can display visual information in the first area 220 in the single shape. The digital device 100 can change from the single shape to the expand shape. In this case, a user may maintain a touch on the digital device 100 to hold the digital device 100. More specifically, a first hand 240 of the user grips the digital device 100 and can maintain the touch on the first area 220. And, the user can change the digital device 100 to the expand shape from the single shape while maintaining a touch on the second area 230 with a second hand 250 of the user. In this case, the digital device 100 can detect the touch of the first hand 240 of the user touching the first area 220 as a touch input. More specifically, the digital device 100 can detect an unintentional touch input of the user, which does not correspond to a touch input for controlling the digital device 100. As an example, the digital device 100 can detect a touch input touching first visual information 210 of the first area 220 touched by the first hand 240 of the user. In this case, the digital device 100 detects the touch input of the user as a control input and may execute a ‘copy’ menu for the first visual information 210 based on the detected touch input. And, as an example, if the digital device 100 is changed from the single shape to the expand shape, the digital device 100 may detect a touch input of the first hand 240 of the user, which is pushed and moved while touching the first area 220, as a control input for moving the first visual information 210. Yet, the aforementioned touch input may correspond to a control input not intended by the user. Hence, when the digital device 100 changed from the single shape to the expand shape, it is necessary for the digital device 100 to determine whether to use a touch input as a control input.

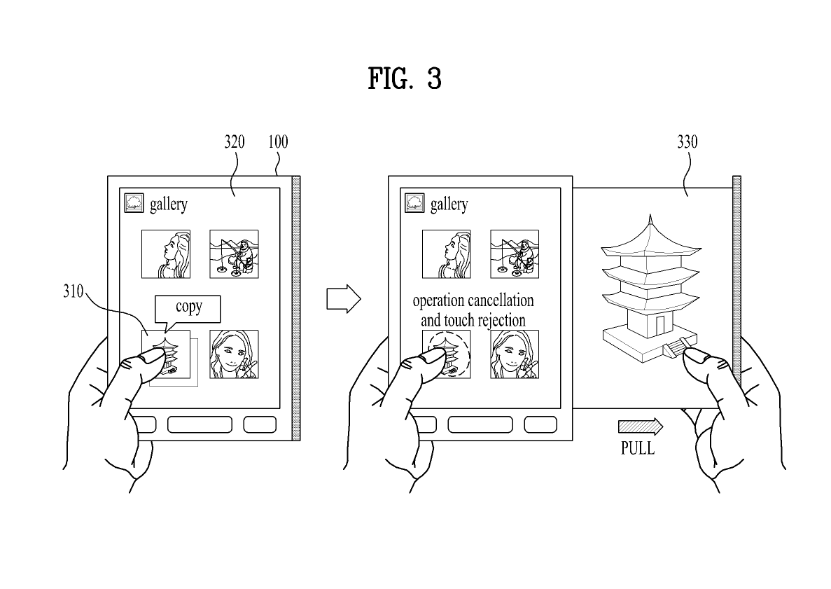

FIG. 3 is a diagram of a method for a digital device to cancel an operation and execute touch rejection according to one embodiment of the present specification in case that a changing of the digital device from a single shape to an expand shape is detected.

If the digital device 100 is changed from the single shape to the expand shape, the digital device 100 can cancel a first operation which has executed based on a first touch input. More specifically, the digital device 100 detects the first touch input and can execute the first operation based on the first touch input. In this case, as an example, the first operation may correspond to an operation for first visual information 310 which is displayed in a position on which the first touch input is detected. The first operation may correspond to an operation executed by the first touch input according to an intention of a user. And, as an example, the first operation may correspond to an operation executed irrespective of the intention of the user in a process of changing the digital device from the single shape to the expand shape.

If it is detected that the digital device 100 is changed from the single shape to the expand shape while the first touch input is maintained, the digital device 100 can cancel the first operation. In this case, as an example, if the first touch input is maintaining, an executing state of the first operation can be maintained. And, as an example, the digital device 100 may not use the maintaining first touch input as a control input for controlling the digital device 100. More specifically, when the digital device is changed from the single shape to the expand shape, although the first touch input is maintained, the digital device 100 may not utilize the first touch input as the control input. In particular, when the digital device 100 is changed from the single shape to the expand shape, the digital device cancels the first operation, which is executed based on the first touch input, and can execute touch rejection for the first touch input that is maintained.

As an example, referring to FIG. 3, before changing from the single shape to the expand shape, the digital device 100 can execute an operation of displaying a ‘copy’ menu for first visual information 310 based on the first touch input. A user can change the digital device 100 to the expand shape from the single shape while maintaining the first touch input. In this case, the digital device 100 cancels the operation, which has displayed the ‘copy’ menu, and can execute touch rejection for the first touch input that is maintained. In particular, the digital device 100 cancels the previously executed operation while changing to the expand shape from the single shape and can ignore the first touch input that is maintained.

And, as an example, if it is detected that the digital device is changed from the single shape to the expand shape, the digital device 100 can cancel the first operation irrespective of whether the first touch input is maintained. More specifically, the digital device 100 can use the changing from the single shape to the expand shape as an undo function cancelling the operation irrespective of whether the first touch input is maintained. In this case, as an example, the digital device 100 can delete data with the first operation. In this case, if it is detected that the single shape is changed to the expand shape, the digital device 100 can restore the deleted data. And, as an example, the digital device 100 can move a displayed object with the first operation. In this case, if it is detected that the single shape is changed to the expand shape, the digital device 100 can reposition the moved object back to an original position. Besides, the digital device 100 can cancel a function, which has been executed based on the first operation, irrespective of whether the first touch input is maintained, by which the present specification may be non-limited.

And, as an example, the digital device 100 can execute a first selection based on the first touch input. In this case, the first selection may correspond to a function selecting a displayed object. In this case, if it is detected that the digital device 100 is changed from the single shape to the expand shape, the digital device 100 can maintain the first selection for first visual information 310. More specifically, if it is detected that the digital device 100 is changed from the single shape to the expand shape, the digital device 100 can maintain the first selection while the first operation is cancelled. In particular, although the digital device 100 cancels the operation which has been executed based on the first touch input, the digital device can maintain the function selecting the first visual information 310. And, as an example, the digital device detects a plurality of control inputs while changing to the expand shape from the single shape and can selectively execute the control inputs, by which the present specification may be non-limited.

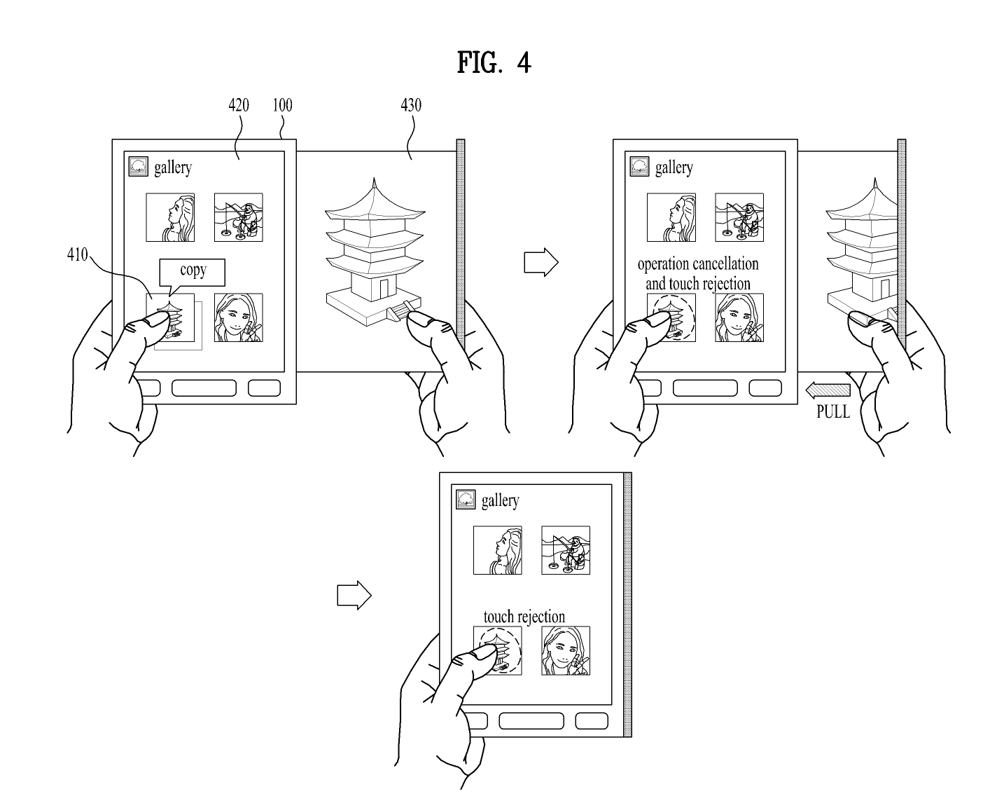

FIG. 4 is a diagram of a method for a digital device to cancel an operation and execute touch rejection according to one embodiment of the present specification in case that a changing of the digital device from an expand shape to a single shape is detected.

The digital device can change from the single shape to the expand shape. And, the digital device can change from the expand shape to the single shape. In this case, the digital device 100 detects a first touch input touching first visual information 410 in the expand shape and can execute a first operation based on the detected touch input. If the digital device 100 is changed from the expand shape to the single shape while maintaining the first touch input, the digital device can cancel the executed first operation. In particular, when the digital device changes to the expand shape from the single shape and changes to the single shape from the expand shape, the digital device cancels a previously executed operation and can ignore the first touch input.

As an example, referring to FIG. 4, the digital device 100 can execute an operation displaying a ‘copy’ menu for first visual information 410 based on the first touch input in the expand shape. In this case, if the digital device 100 is changed from the expand shape to the single shape while maintaining the first touch input, the display device 100 cancels the operation, which has displayed the ‘copy’ menu, and can execute touch rejection for the first touch input that is maintained.

FIG. 5 is a diagram of a method for a digital device to detect a maintained touch input as a new touch input after the digital device has changed from a single shape to an expand shape according to one embodiment of the present specification.

The digital device 100 can detect a first touch input in the single shape. In this case, the digital device 100 can execute a first operation based on the first touch input. Subsequently, it may detect that the digital device 100 is changed from the single shape to the expand shape. In this case, the digital device can cancel the first operation. And, the digital device 100 can execute touch rejection for the first touch input for a shape changing time corresponding to a time between a start of the changing to the expand shape from the single shape and a completion of the changing to the expand shape from the single shape. More specifically, the digital device 100 detects the first touch input for the shape changing time. Yet, the digital device may not use the detected first touch input as a control input controlling the digital device. And, the digital device 100 can detect that the first touch input is maintaining after the changing from the single shape to the expand shape is completed. In this case, as an example, although the first touch input, which is maintaining after the changing is completed, is detected, the digital device may not utilize the detected first touch input as a control input controlling the digital device. And, as an example, if the digital device 100 detects that the first touch input is maintaining for more than a threshold time from timing of completion of the changing to the expand shape from the single shape, the digital device can detect the first touch input as a new second touch input. In this case, the threshold time may correspond to a threshold time configured to detect the first touch input as the new second touch input and may have a prescribed error range. And, the threshold time can be configured by a user or the digital device 100. The digital device 100 can execute the first operation again based on the detected second touch input. And, as an example, the digital device 100 can execute a second operation different from the first operation based on the detected second touch input, by which the present specification may be non-limited.

As a different example, the digital device 100 can detect that the changing from the single shape to the expand shape is completed and the maintained first touch input is released. In this case, if the digital device 100 detects a new second touch input touching a first area, the digital device 100 can execute a first operation based on the detected second touch input. In particular, the digital device 100 can control the digital device 100 based on a new touch input after the changing from the single shape to the expand shape is completed, by which the present specification may be non-limited.

As an example, referring to FIG. 5, the digital device 100 can execute an operation displaying a ‘copy’ menu for first visual information 510 based on the first touch input. In this case, if the changing from the single shape to the expand shape starts, the digital device 100 can cancel the displayed operation for the ‘copy’ menu. And, the digital device 100 can execute touch rejection for the first touch input for the shape changing time. And, the digital device 100 can execute the touch rejection for the first touch input from the timing that the changing from the single shape to the expand shape is completed to the threshold time. Subsequently, if the digital device 100 maintains the first touch input until a timing point appearing after the threshold time, the digital device 100 detects the first touch input as a second touch input and can execute the operation displaying the ‘copy’ menu for the first visual information 510 again.

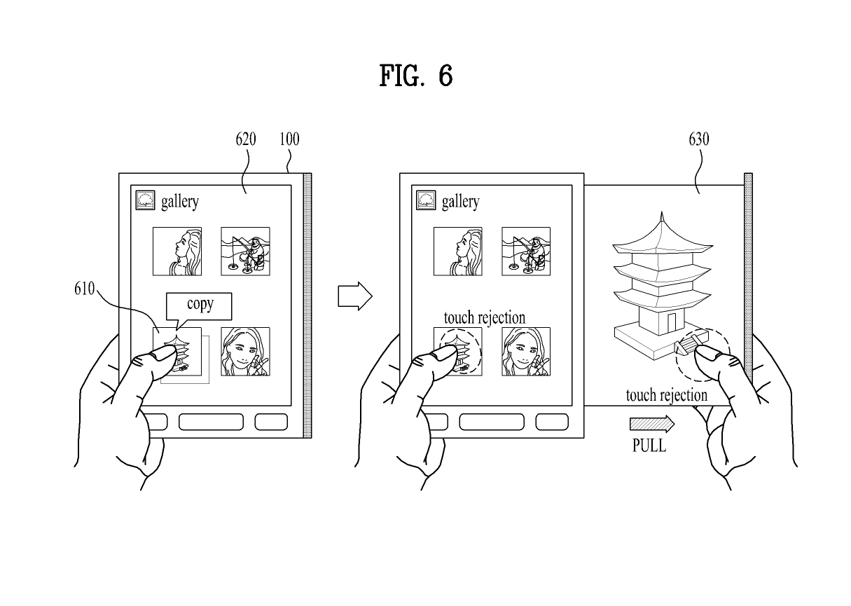

FIG. 6 is a diagram of a method for a digital device to execute touch rejection on each of a first area of the digital device and a second area of the digital device according to one embodiment of the present specification.

The digital device 100 can execute a first operation based on a first touch input touching a first area 620. In this case, as mentioned in the foregoing description, if it is detected that the digital device 100 is changed from the single shape to the expand shape, the digital device 100 can cancel the first operation. And, the digital device 100 can execute touch rejection for the first touch input. If it is detected that the digital device 100 is changed from the single shape to the expand shape, the digital device 100 can detect a second touch input touching a second area 630. In this case, the digital device 100 can execute touch rejection for the second touch input in the middle of shape changing time for which the single shape is changing to the expand shape. More specifically, although the digital device 100 detects the second touch input, the digital device may not utilize the second touch input as a control input controlling the digital device 100. As an example, a user can maintain the second touch input for the second area 630 to change the shape of the digital device to the expand shape from the single shape. In particular, the user can maintain the second touch input to change the shape of the digital device 100. Hence, the user may not use the second touch input as the control input controlling the digital device 100. In this case, the digital device 100 can execute the touch rejection for the second touch input while the digital device is changed from the single shape to the expand shape.

And, as an example, the digital device 100 can detect a touch input touching at least one of the first area 620 and the second area 630 using a sensor unit 110. In this case, the digital device 100 can deactivate a touch sensor unit configured to detect a touch input touching the first area 620 for the shape changing time for which the single shape is changing to the expand shape. More specifically, the digital device 100 may not detect a touch input for a whole area of the first area 620 for the shape changing time. And, as an example, although the digital device 100 detects a touch input for the whole area of the first area 620, the digital device may not utilize the detected touch input as a control input controlling the digital device 100.

And, as an example, the digital device 100 can deactivate the touch sensor unit configured to detect a touch input touching the second area 630 for the shape changing time for which the single shape is changing to the expand shape. More specifically, the digital device 100 may not detect a touch input for a whole area of the second area 630 for the shape changing time. And, as an example, although the digital device 100 detects a touch input for the whole area of the second area 630, the digital device may not utilize the detected touch input as a control input controlling the digital device 100.

In particular, the digital device 100 can configure a touch input not to control the digital device 100 during the shape changing time for which the single shape is changing to the expand shape.

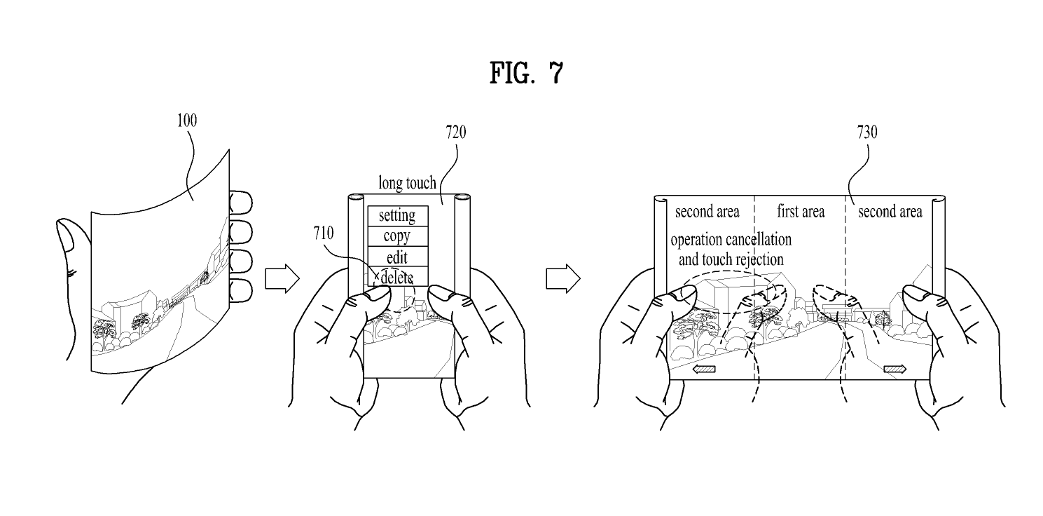

FIG. 7 is a diagram of a method for a flexible digital device to change to an expand shape from a single shape according to one embodiment of the present specification.

The digital device 100 can be manufactured by a flexible material. As an example, the digital device 100 can be manufactured by an e-paper. In this case, if the digital device 100 is folded or rolled up, the digital device 100 can be configured as a single shape. And, if the digital device 100 is unfolded, the digital device 100 can be configured as an expand shape. In this case, the digital device 100 can configure a second area 730 as an area expanded from a first area 720. More specifically, the digital device 100 can configure an area expanded by unfolding the digital device 100 as the second area 730. In this case, the digital device 100 can change from the single shape to the expand shape in a manner of moving a first touch input to a second position from a first position. In this case, as an example, the first position may be located at the first area 720 and the second position may be located at the second area 730. In particular, the digital device 100 can change from the single shape to the expand shape in a manner that a user unfolds the folded or rolled digital device.

If the digital device 100 detects the changing from the single shape to the expand shape while the first touch input is moving from the first position to the second position, although the digital device 100 detects movement information of the first touch input, the digital device may not utilize the movement information of the detected first touch input as a control input controlling the digital device 100. In particular, the digital device 100 just recognizes the movement information on the first touch input as an operation for changing from the single shape to the expand shape and may not use the movement information as the control input controlling the digital device 100.

As an example, referring to FIG. 7, when a part of the digital device is folded, the digital device 100 can be configured as the single shape. In this case, as an example, the digital device 100 can configure an area in which visual information is displayed as a first area 720. The digital device 100 can execute an operation displaying an ‘editing menu’ for first visual information 710 with the first touch input touching the first area 720. In this case, the digital device 100 can change from the single shape to the expand shape in a manner that the maintained first touch input moves to the second position from the first position. In this case, as an example, the second area 730 may correspond to an area expanded from the first area 720 by unfolding the display device 100. While the single shape is changing to the expand shape, the digital device 100 can cancel the operation for the displayed ‘editing menu’. And, while the single shape is changing to the expand shape, the digital device 100 can execute touch rejection for the first touch input, which moves from the first position to the second position.

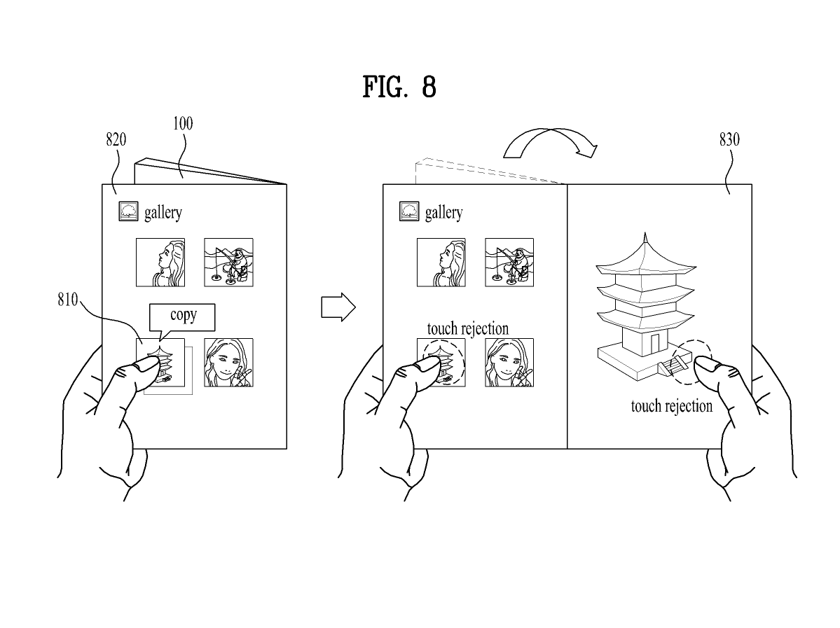

FIG. 8 is a diagram of a method for a foldable digital device to change from a single shape to an expand shape according to one embodiment of the present specification.

A digital device 100 capable of being folded can be manufactured. In this case, when the digital device 100 is folded, the digital device 100 can configure a single shape. In this case, the digital device 100 can provide a first area 820 to a user as a control area. When the digital device 100 is unfolded, the digital device 100 can configure an expand shape. In this case, the digital device 100 can provide the first area 820 and a second area 830 to the user as the control area. In particular, the digital device 100 can configure the single shape or the expand shape based on whether the digital device is folded. The digital device 100 can execute a first operation with a first touch input touching the first area 820 in the single shape. The first operation may correspond to an operation displaying a ‘copy’ menu for first visual information 810. In this case, while the first touch input is maintained, if the digital device 100 detects that the single shape is changing to the expand shape, the digital device 100 cancels the first operation and can execute touch rejection for the maintained first touch input. And, as an example, the digital device 100 can detect a second touch input during changing time for which the single shape is changing to the expand shape. In this case, the digital device 100 can execute touch rejection for the second touch input. In particular, although the digital device 100 detects the second touch input, the digital device may not utilize the second touch input as a control input controlling the digital device 100.

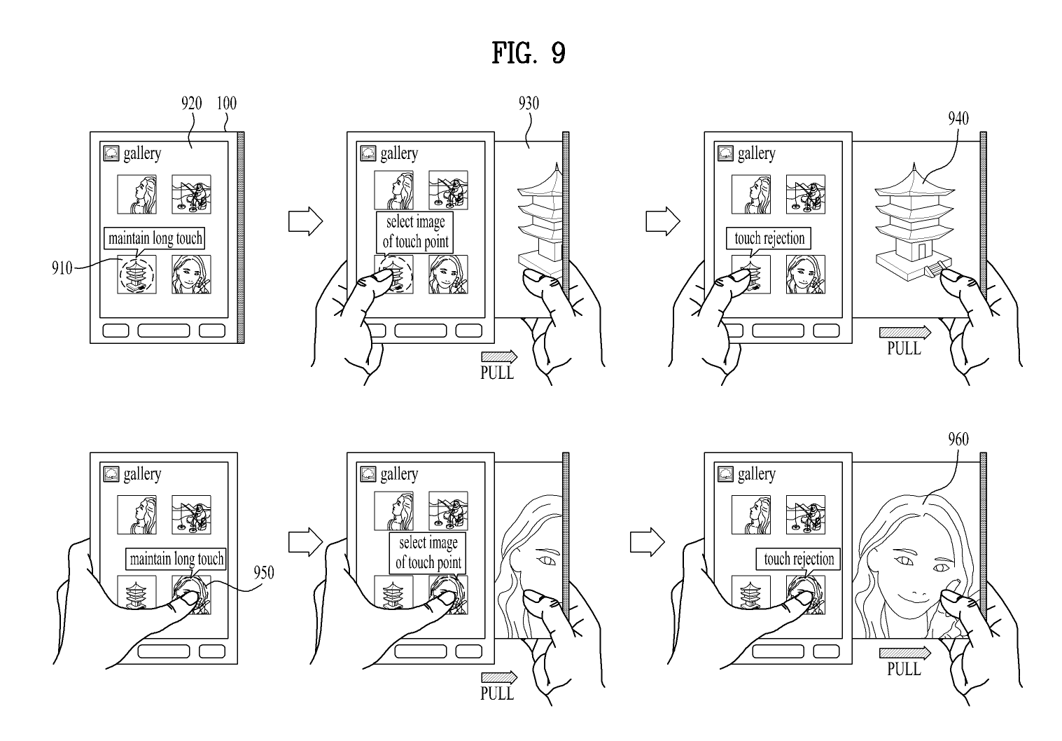

FIG. 9 is a diagram of a method for a digital device to display visual information in a second area of the digital device based on a touch input touching the visual information displayed in a first area of the digital device according to one embodiment of the present specification.

The digital device 100 can display visual information in at least one of a first area 920 and a second area 930. In this case, the digital device 100 can display the visual information in the first area 920 in the single shape. And, the digital device 100 can display the visual information in both the first area 920 and the second area 930 in the expand shape.

In this case, as an example, the digital device 100 can display first visual information 910 in the first area 920 in the single shape. In this case, the digital device 100 can detect a first touch input touching the first visual information 910 displayed in the single shape. Subsequently, the display device 100 can detect a changing from the single shape to the expand shape while the first touch input is maintaining. In this case, the digital device 100 can display second visual information 940 corresponding to the first visual information 910 in the second area 930. In this case, as an example, the second visual information 940 may correspond to visual information enlarged from the first visual information by a reference ratio.

And, the digital device 100 can display third visual information 950 in the first area 920 in the single shape. In this case, the digital device 100 can detect a second touch input touching the third visual information 950 displayed in the single shape. Subsequently, the digital device 100 can detect a changing from the single shape to the expand shape while the second touch input is maintaining. In this case, the digital device 100 can display fourth visual information 960 corresponding to the third visual information 950 in the second area 930. In this case, as an example, the fourth visual information 960 may correspond to visual information enlarged from the third visual information 950 by a reference ratio. In particular, the digital device 100 can display the visual information, which is selected based on a touch input in the single shape, in the second area 930 in the expand shape. In particular, the digital device 100 can execute a function for selecting visual information displayed in a position on which a touch input is detected although an operation is cancelled.

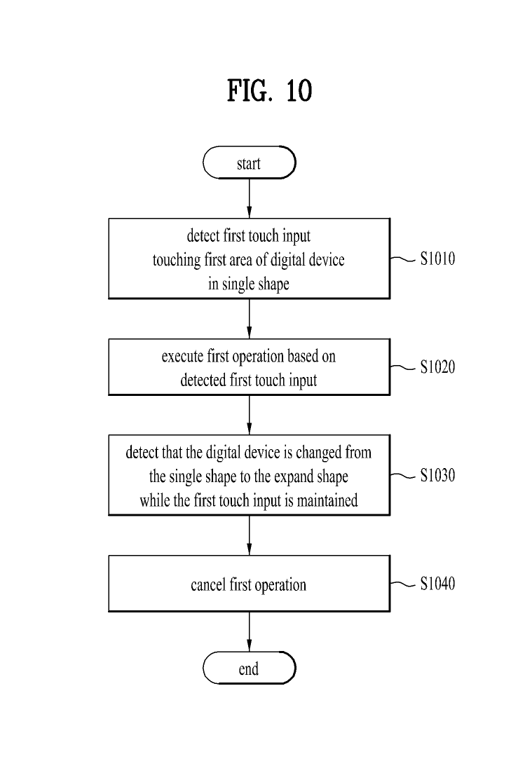

FIG. 10 is a flowchart for a method of controlling a digital device according to one embodiment of the present specification.

The digital device 100 can detect a first touch input touching a first area of the digital device 100 in a single shape [S1010]. In this case, as mentioned earlier in FIG. 1, the digital device 100 can provide the first area among the first area and a second area of the digital device 100 to a user as a control area in the single shape. In this case, as an example, the digital device 100 detects a touch input touching the first area only and can deliver the detected touch input to a processor. And, as an example, the digital device can display visual information in the first area only. In particular, the digital device 100 can provide the first area to the user as a display area controllable by the user in the single shape.

And, if the digital device 100 is configured as an expand shape, the digital device 100 can provide the first area and the second area to the user as a control area. In this case, as an example, the digital device 100 detects a touch input touching the first area and the second area and can deliver the detected touch input to the processor. And, as an example, the digital device 100 can display visual information in the first area and the second area. In particular, the digital device 100 can provide the first area and the second area to the user as a plurality of display areas controllable by the user in the expand shape.

Subsequently, the digital device 100 can execute a first operation based on the detected first touch input [S1020]. In this case, as mentioned earlier in FIG. 3, the digital device 100 can execute the first operation based on the first touch input. And, as an example, the first operation may correspond to an operation controlling first visual information displayed in a position on which the first touch input is detected. And, as an example, the digital device 100 can execute a first selection selecting the first visual information based on the first touch input. As an example, the first operation may correspond to an operation deleting data, an operation moving a displayed object or a function executed by the digital device 100.

Subsequently, the digital device 100 can detect that the digital device 100 is changed from the single shape to the expand shape while the first touch input is maintained [S1030]. In this case, as mentioned earlier in FIG. 1, the digital device 100 can be configured as the single shape or the expand shape based on a physical form of the digital device 100. And, the digital device 100 can detect that the digital device is changed from the single shape to the expand shape using a sensor unit 110. More specifically, the digital device 100 can detect that the physical form of the digital device 100 is changing using the sensor unit 110. In this case, the sensor unit 110 can include at least one selected from the group consisting of an acceleration sensor, a terrestrial magnetism sensor, a vibration sensor and a power sensor. And, the sensor unit may include a sensor capable of detecting a change of the physical form of the digital device 100, by which the present specification may be non-limited.

Subsequently, the digital device can cancel the first operation [S1040]. In this case, as mentioned earlier in FIG. 3, if the first touch input is maintained, an executed state of the first operation can be maintained. In this case, the digital device 100 may not use the maintained first touch input as a control input controlling the digital device 100. More specifically, although the first touch input is maintained while the digital device is changed from the single shape to the expand shape, the digital device 100 may not utilize the first touch input as the control input. In particular, when the digital device is changed from the single shape to the expand shape, the digital device 100 cancels the first operation which is based on the first touch input and can execute touch rejection for the maintained first touch input. And, the digital device 100 can maintain a first selection for first visual information 310 in the single shape. More specifically, if it is detected that the digital device 100 is changed from the single shape, although the digital device 100 cancels the first operation, the digital device can maintain the first selection. In particular, although the digital device 100 cancels the operation which is executed based on the first touch input, the digital device can maintain a function selecting the first visual information 310.

For clarity of explanation, each diagram is explained in a manner of being divided. Yet, it is possible to design a new embodiment to implement the new embodiment by combining the embodiments, which are described in each of the diagrams. And, according to the necessity of those skilled in the art, designing a recording media readable by the computer, which has recorded a program for executing the previously explained embodiments, also belongs to a scope of a right.

A digital device 100 according to the present specification and a method of controlling therefor may not limitedly apply to the composition and method of the aforementioned embodiments. The aforementioned embodiments may be configured in a manner of being selectively combined the whole of the embodiments or a part of the embodiments to achieve various modifications.

Meanwhile, a digital device 100 according to the present specification and a method of controlling therefor can be implemented with a code readable by a processor in a recording media readable by the processor, which is equipped in a network device. The recording media readable by the processor may include all kinds of recording devices for storing data capable of being read by the processor. The examples of the recording media readable by the processor may include a ROM, a RAM, a magnetic tape, a floppy disc, an optical data storing device and the like. And, implementing in a form of a carrier wave such as a transmission via the internet and the like is also included. And, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on both of the inventions can be complementally applied, if necessary.

What is claimed is:

1. A digital device having a single shape and an expand shape, comprising:
a touch sensor unit configured to detect a touch input touching a first area of the digital device and deliver the detected touch input to a processor;
a sensor unit configured to detect a change from the single shape to the expand shape; and
the processor configured to control the touch sensor unit and the sensor unit,
wherein the processor is further configured to:
execute a first operation based on a first touch input when the first touch input is detected on the first area in the single shape,
cancel the first operation upon detecting that the digital device is changed to the expand shape from the single shape while the first touch input is maintained.

2. The digital device of claim 1, wherein the digital device comprises the first area and a second area.

3. The digital device of claim 2, wherein the processor is further configured to:
provide the first area to a user as a control area among the first area and the second area when the digital device is in the single shape.

4. The digital device of claim 2, wherein the processor is further configured to:
provide the first area and the second area to a user as a control area when the digital device is in the expand shape.

5. The digital device of claim 1, wherein the processor is further configured to:
maintain an execution state of the first operation when the first touch input is maintained.

6. The digital device of claim 1, wherein the processor is further configured to:
execute a first selection based on the detected first touch input, and
wherein if the changing to the expand shape from the single shape is detected, maintain the first selection.

7. The digital device of claim 1, wherein the processor is further configured to deactivate the touch sensor unit on the first area during a shape changing time for which the single shape is changing to the expand shape.

8. The digital device of claim 2, wherein the touch sensor unit is further configured to detect a touch input touching the second area.

9. The digital device of claim 8, wherein the processor is further configured to deactivate the touch sensor unit for the second area during a shape changing time for which the single shape is changing to the expand shape.

10. The digital device of claim 1, wherein the processor is further configured to:
if it is detected that the first touch input is maintained after the changing to the expand shape from the single shape is completed, detect the first touch input using the touch sensor unit and ignore and disregard the detected first touch input as a control input controlling the digital device.

11. The digital device of claim 10, wherein the processor is further configured to:
if it is detected that the maintained first touch input is further maintained for more than a threshold time from timing of completion of the switching to the expand shape from the single shape, detect the first touch input as a second touch input and execute the first operation based on the detected second touch input.

12. The digital device of claim 1, wherein the processor is further configured to:
complete the changing to the expand shape from the single shape,
detect the maintained first touch input is released, and
execute the first operation based on a second touch input when the second touch input touching the first area is detected.

13. The digital device of claim 1, wherein the processor is further configured to:
execute the first operation based on a first touch input when the first touch input touching the first area is detected in the expand shape, and
cancel the first operation upon detecting that the digital device is changed to the single shape from the expand shape while the first touch input is maintained,

14. The digital device of claim 1, wherein cancelling the executed first operation corresponds to one of restoring a deleted data based on the first operation, repositioning a moved object back to an original position based on the first operation and undoing an executed function based on the first operation.

15. The digital device of claim 2, further comprising a display unit configured to display visual information in at least one of the first area and the second area.

16. The digital device of claim 15, wherein the processor is further configured to:
display first visual information in the first area,
detect the first touch input touching the displayed first visual information in the single shape, and
display second visual information corresponding to the first visual information in the second area upon detecting that the digital device is changed to the expand shape from the single shape.

17. The digital device of claim 2, wherein the digital device corresponds to a flexible device, and
wherein the second area is expanded from the first area by unfolding the flexible device.

18. The digital device of claim 17, wherein the processor is further configured to:
if the switching to the expand shape from the single shape is detected while the first touch input is moving from a first position to a second position, detect movement information of the first touch input using the touch sensor unit and disregard the movement information of the detected first touch input as a control input controlling the digital device.

19. The digital device of claim 18, wherein the first position is located at the first area and the second position is located at the second area which is expanded from the first area.

20. A method of controlling a digital device having a single shape and an expand shape, comprising the steps of:
detecting a first touch input touching a first area of the digital device in the single shape;
executing a first operation based on the detected first touch input; and
cancelling the first operation upon detecting that the digital device is changed to the expand shape from the single shape while the first touch input is maintained.
